(19) United States
(12) Patent Application Publication
(10) Pub. No.: US 2007/0122734 A1
(43) Pub. Date: May 31, 2007

(54) Molecular photoresist

(76) Inventors: Jeanette M. Roberts, Portland, OR (US); Heidi B. Cao, Portland, OR (US); Wang Yueh, Portland, OR (US)

Correspondence Address: TROP PRUNER & HU, PC, 1616 S. VOSS ROAD, SUITE 750, HOUSTON, TX, 77057-2631, US

(21) Appl. No.: 11/273,667

(22) Filed: Nov. 14, 2005

(51) Int. Cl. G03C 1/00

(52) U.S. Cl. 430/270.1

(57) ABSTRACT

In one embodiment, a photoacid generator is attached to a primary resist molecule having a radius of gyration of less than about 3 nanometers, the primary molecule other than a traditional photoresist polymer. This embodiment may have increased homogeneity and decreased acid diffusion, which may increase the sensitivity of the resist and decrease line width roughness.

### BACKGROUND

This invention relates generally to semiconductor fabrication and particularly to photolithography.

Photolithography is a process that is used to print a three-dimensional pattern on the surface of a wafer. Generally, to produce a pattern, light-sensitive photoresist material is deposited on a wafer and a portion of the resist is exposed to a source of radiation through a reticle or mask. As a result of exposure, the photoresist may become either more or less soluble in a developer solution. That is, the solubility of the exposed regions of the photoresist may be switched and the soluble portions of the photoresist are removed during development. After resist development, the wafer may undergo additional processing to transfer the photoresist pattern to the material underlying the photoresist. In some instances the photoresist pattern defines features on the wafer such as vias or interconnects.

A trend in the semiconductor industry is to increase the level of integration. One way to increase integration is to decrease feature size. However, feature size is dependent upon lithography; the size of a feature can only be as small as the lithographic process permits.

Chemically amplified resists may be used to pattern wafers with devices having critical dimensions in the sub micrometer range. Generally, chemically amplified resists include a photoacid generator (PAG), which produces an acid upon exposure to radiation. The acid reacts with protecting groups to switch the solubility characteristics of the resist.

Acid diffusion in chemically amplified photoresists may contribute to line width roughness (LWR). Another potential source of LWR is the lack of photoresist homogeneity. Line width roughness is the amount of width variation of a line along its length caused by rough sides. Line width roughness may negatively impact device performance and interconnect resistance, which in turn may negatively impact processor performance.

Thus, there is a continuing need for photoresists that enable resolution of small features and decrease line width roughness.

### BRIEF DESCRIPTION OF THE DRAWINGS

FIG. 1 is an enlarged partial cross-section of a substrate coated with a molecular photoresist according to an embodiment of the present invention;

FIG. 2 shows an example of a generic structure of a multifunctional molecular photoresist molecule according to an embodiment of the present invention;

FIG. 3 illustrates one example of a multifunctional molecular photoresist molecule according to an embodiment;

FIG. 4 illustrates another example of a multifunctional molecular photoresist molecule according to an embodiment;

FIG. 5 shows another generic structure of a multifunctional molecular photoresist molecule in accordance with an embodiment of the present invention; and

FIG. 6 is a flowchart illustrating a method of using an embodiment of a molecular photoresist according to some embodiments.

### DETAILED DESCRIPTION

In an embodiment of the present invention, attaching a photoacid generator (PAG) to the primary molecules of a molecular photoresist may provide a molecular photoresist with improved performance. For example, a primary component of a molecular photoresist that is modified to have one or more PAGs attached thereto may result in a molecular photoresist showing improved sensitivity, resolution, and line width roughness (LWR).

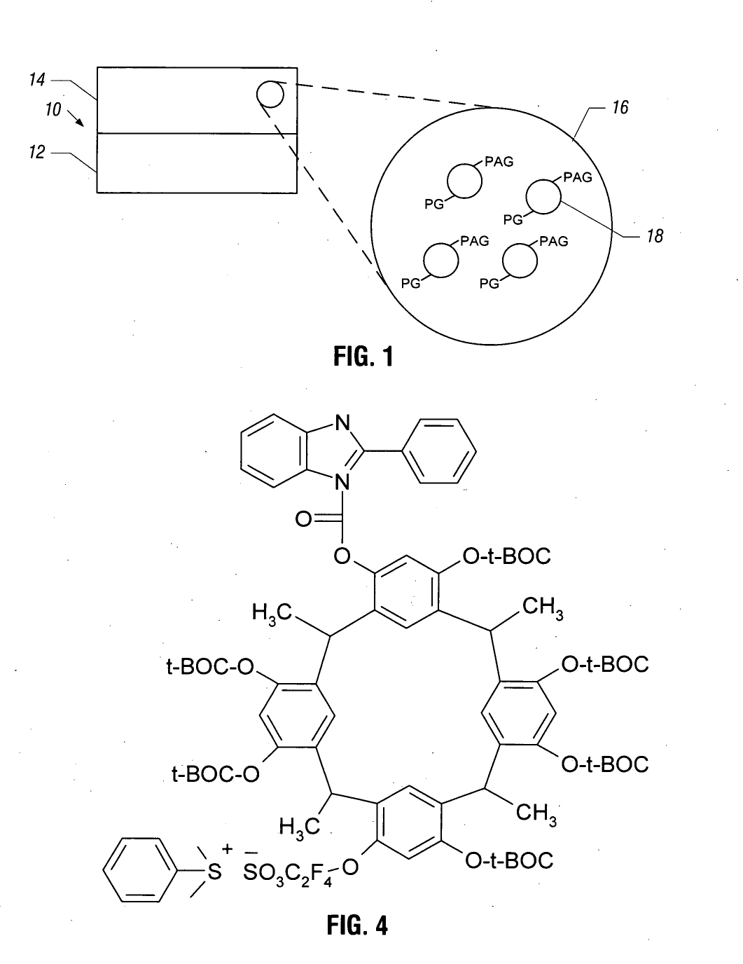

Referring to FIG. 1, according to some embodiments of the present invention, a molecular photoresist 14 including a multifunctional resist molecule may be deposited on a substrate 12. In one embodiment, the substrate 12 may be a wafer with one or more layers of material formed thereon (not shown) to form a structure 10. The one or more layers may eventually be subjected to etching or another wafer fabrication process. Notably, a wafer having one or more layers of material formed thereon is illustrative of one application in which an embodiment of the present invention may be used and is not to be construed as limiting. Those skilled in the art will appreciate that embodiments of the present invention may have other applications.

As shown in a close-up 16, a photoacid generator (PAG) may be attached to a resist constituent 18 to form a molecular photoresist 14 according to an embodiment of the present invention. The primary molecules 18 may also have a protecting group (PG) attached thereto.

According to an embodiment of the present invention, the primary molecules 18 are relatively small compared to traditional polymeric photoresists such as t-butoxycarbonyl polyhydroxystyrene and t-butyl acrylate polyhydroxystyrene. For example, some polyhydroxystyrenes are high molecular weight, having a radius of gyration (Rg) of about 4.0 nanometers (nm) to about 5.5 nm. Other polyhydroxystyrenes are low molecular weight, having an Rg of about 2.5 nm. In some embodiments, the Rg of a primary constituent 18 may be less than about 3 nm, and in some embodiments less than about 2 nm. In one embodiment, the primary constituent 18 of a multifunctional molecular resist molecule may have an Rg of about 1.2 nm. Thus, some embodiments of the present invention may include a primary constituent or primary molecule that is relatively small and that may, in some instances, be an oligomer or have a ring structure.

In the close-up 16, the primary molecules 18 are depicted as circles. The circles are for illustrative purposes and are not to be construed as limiting. In particular, the primary constituent of a multifunctional molecular resist molecule is not limited to a ring structure, which is evident from the following disclosure.

In an embodiment of the present invention, the photoacid generator (PAG) attached to the primary molecule 18 may be any suitable PAG. For example, the PAG may be an ionic salt. The ionic salt may have a photoactive, positively charged cation, or counter-ion (a chromophore), and a negatively charged anion such as triflate, hexaflate, or nonaflate, although embodiments are not so limited. In some embodiments, upon exposure to extreme ultraviolet light (EUV), the anion may be transformed into an acid such as trifilic acid. Examples of ionic PAGs that may be attached to a primary molecule according to an embodiment of the present invention include, but are not limited to, triphenylsulfonium nonaflate (TPS-NF), triphenylsulfonium triflate (TPS-TF), and/or diphenyliodium nonaflate (DPI-NF).

In embodiments where an ionic PAG is attached to a primary molecule, the PAG may be attached at either the anionic or the cationic portion. Furthermore, one or more of the same ionic PAG may be attached to a given primary molecule. Alternatively, different ionic PAGs may be attached to a given primary molecule.

Photoacid generators that are attached to the primary molecules are not limited to ionic salts; non-ionic PAGs such as norbornene dicarboximidyl trifilate and norbornene dicarboximidyl nonaflate may also be attached, although embodiments are not so limited. As with ionic PAGs, one or more of one type of non-ionic PAG may be attached to a given primary molecular resist component. Alternatively, in some instances more than one type of PAG may be attached to the primary component, including an ionic and/or a non-ionic PAG.

As shown in the close up 16, a protecting group (PG) may also be bound to the primary component 18, in some embodiments. For example, a primary molecule 18 may have one or more of the following protecting groups attached thereto, although embodiments are not so limited: tert-butoxycarbonyl (t-BOC) tert-butyl acrylate (TBA), t-butyl methacrylate (t-BMA), methyl methacrylate, t-butoxycarbonylmethyl (BOCMe), methoxyethoxymethyl, and t-butyl ether.

Generally, protecting groups provide a solubility switch that renders exposed portions of a photoresist more or less soluble in developer solution. For example, PAGs in a chemically amplified photoresist generate an acid after exposure to a source of radiant energy. An acid-catalyzed deprotection reaction cleaves the protecting groups, which in some instances increases the solubility of the exposed portions of the resist. Acid diffusion, especially at the boundary of the exposed/unexposed resist, may result in unwanted dissolution of the resist. Unwanted dissolution may increase line width roughness in the feature patterned by the resist.

Binding one or more PAGs to a primary molecular resist component may increase the sensitivity and resolutions of the molecular resists. Moreover, a molecular resist including a multifunctional molecular photoresist molecule may exhibit decreased acid diffusion and in-homogeneity. As a result, smaller critical dimensions and decreased line width roughness may be achieved. For example, if one or more PAGs are attached to the primary resist molecules, the acid produced after irradiation may not diffuse as readily through the resist. If diffusion distances decrease there may be a corresponding decrease in line width roughness. Additionally, if one or more PAGs are attached to a primary component of a molecular resist, the resultant molecular resist may have increased homogeneity, which may help reduce the size of the smallest developable unit and may provide a more uniform dissolution. A more uniform dissolution may decrease line width roughness. Binding one or more PAGs to the primary component of a molecular resist may also allow more efficient energy transfer to the PAG, and higher PAG loadings without phase separation or reaching solubility limitations. This too may improve the sensitivity and/or homogeneity of a molecular resist incorporating an embodiment of a multifunctional resist molecule.

Although not shown in the close-up 16, the photoresist 14 may have been dissolved in a solvent such as propylene glycol methyl ether acetate (PGMEA) to liquefy the photoresist for dispensing to coat the substrate 12. The liquefied molecular resist may include, in addition to an embodiment of a multifunctional molecular resist molecule, one or more additives such as surfactants, adhesion promoters, and/or base quenchers. In some embodiments of the present invention, a base quencher may be attached to the primary molecular resist component.

In embodiments where a base quencher is attached to the primary molecules 18 (not shown), any suitable base quencher may be utilized. Exemplary base quenchers include, but are not limited to, tetrabutylammonium hydroxide (TBAH), trioctylamine, triethanolamine, tetrethylamine, tetrabutylamine, and aromatic amines. Binding a base quencher to a multifunctional molecular photoresist molecule may also limit acid diffusion distance to improve resist resolution, contrast, and/or line width roughness.

In embodiments of the present invention, the ratio of protecting groups, PAGs and/or base quenchers appended to the primary component depends on the competing requirements for contrast, adhesion, sensitivity and/or other photoresist parameters. Accordingly, embodiments of the present invention are not limited to any particular ratio of attached groups.

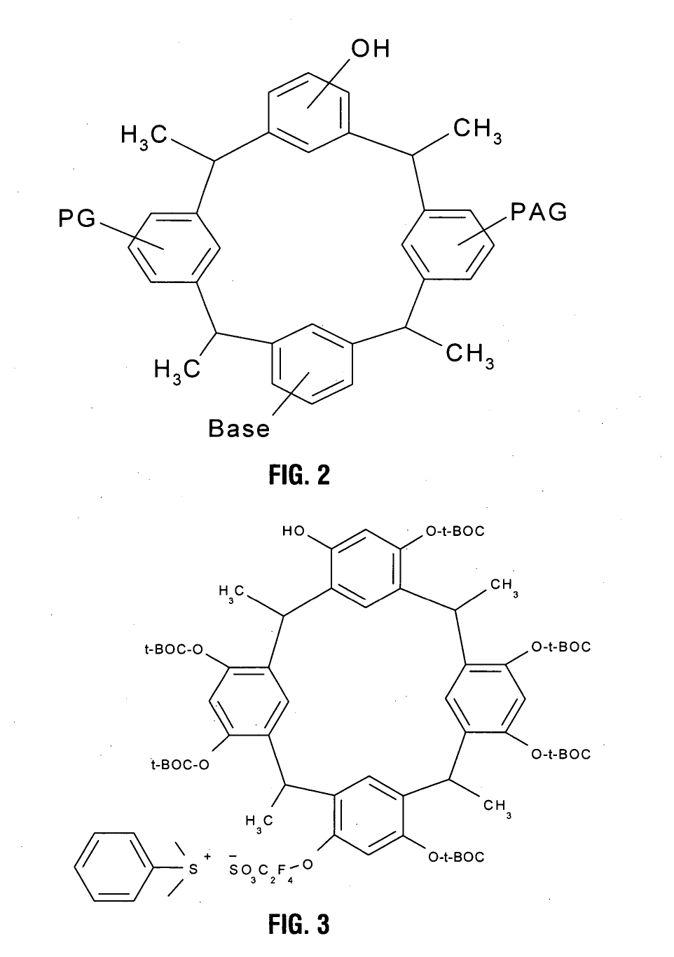

Referring to FIG. 2, an example of a multifunctional molecular resist molecule is illustrated according to an embodiment of the present invention. The primary molecule shown in FIG. 2 is relatively small and rigid, and is generally ring-shaped. In some instances, the ring-shaped structure may be a derivative of calixarene.

As shown in FIG. 2, a protecting group (PG), photoacid generator (PAG), and/or base quencher (Base) are attached to the primary component. These different moieties may be attached to the primary constituent as previously described. In some embodiments, the protecting group may be a protecting group such as t-BOC, TBA, t-BMA, BoCMe, methyl methacrylate, methoxyethoxymethyl, and/or t-butyl ether, although embodiments are not so limited. Additionally, the photoacid generator may be any one or more of triphenylsulfonium nonaflate, triphenylsulfonium triflate, diphenyliodium nonaflate, norbornene dicarboximidyl nonaflate, and norbornene dicarboximidyl triflate, although embodiments are not limited thereto. Likewise, where utilized, a base quencher may be any one or more of tetrabutylammonium hydroxide, trioctylamine, triethanolamine, tetrabutylamine, tetrethylamine, and an aromatic amine, without limitation to these examples.

The groups appended to the primary molecule and their places of attachment as shown in FIG. 2 are exemplary; the actual number and placement of appended groups may vary depending on the desired characteristics of the resist. In other words, a primary constituent of a molecular resist may have one or more suitable PGs and/or PAGs attached thereto. Furthermore, in embodiments having more than one PAG, the types of PAGs do not have to be the same; they may be blended. However, one embodiment of a multifunctional molecular resist molecule may have a single type of PAG and PG attached thereto.

Although a base quencher is shown attached to the structure in FIG. 2, a base quencher may be added to a resist solution instead of, or in addition to, being attached to the primary molecule. In those embodiments in which a base quencher is attached to the primary component, the base quenchers may all be of the same type, or they may be blended.

Referring to FIG. 3, one specific example of a multifunctional molecular photoresist molecule is illustrated. This multifunctional resist molecule is a derivative of calixarene and is protected by t-BOC. The calixarene derivative has been modified to have an ionic photoacid generator including a sulphonium chromophore and nonaflate anion attached thereto. As shown, the PAG is attached to the primary molecule by the anionic portion.

Referring to FIG. 4, another example of a multifunctional molecular photoresist molecule is illustrated. In this example, the primary molecule is also a calixarene derivative protected by t-BOC and having an ionic PAG bound thereto. In addition, this exemplary multifunctional molecular resist molecule has an attached base quencher.

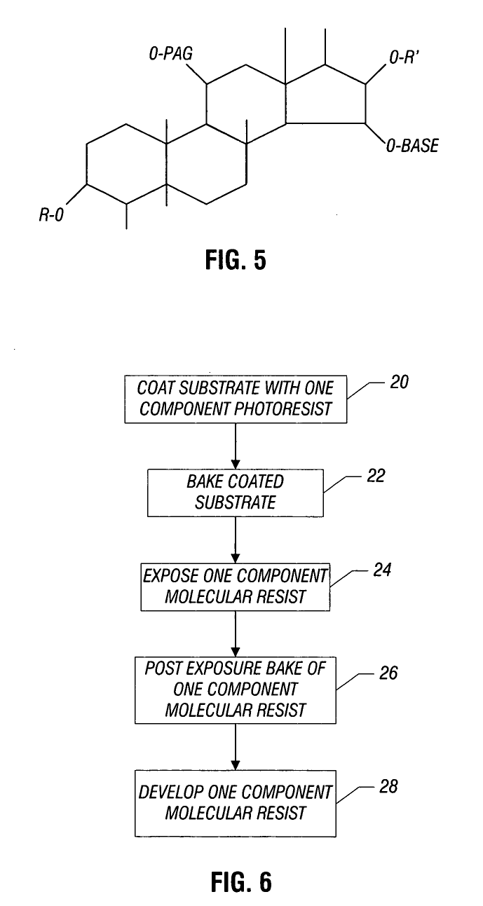

Referring to FIG. 5, another exemplary multifunctional molecular photoresist molecule is illustrated according to an embodiment of the present invention. In this example, the primary molecule is an oligomer having four fused rings. The oligomer is also relatively small compared to polymer resins of traditional resists. An oligomer, according to some embodiments of the present invention, is not limited to the example shown; it may be any small molecule other than a traditional polymeric resist material, including organic oligomers.

As shown in FIG. 5, a photoacid generator (O-PAG) is attached to the oligomer. The PAG may be any suitable PAG such as TPS-NF, TPS-TF, DPI-NF, norbornene dicarboximidyl nonaflate, and/or norbornene dicarboximidyl triflate, although embodiments are not limited to these examples. Ionic PAGs may be attached to the oligomer at either the anion or cation.

In some embodiments, more than one PAG may be attached to an oligomer; the PAGs may or may not be blended. Moreover, a PAG may be attached to an oligomer at any suitable position and are not limited to the positions illustrated in FIG. 5.

A base quencher (O-BASE) may also be attached to the oligomer as shown in the figure, although embodiments are not so limited. Where a base quencher is attached, the base quencher may be any suitable base quencher, such as TBAH, trioctylamine, triethanolamine, tetrethylamine, tetrabutylamine, and/or an aromatic amine.

Other moieties may be attached to the oligomer. For example, moieties R and R′ may be an alkyl and/or aromatic. R and R′ may also be a PAG and/or a base quencher. In some embodiments, R and R′ may be different. In embodiments where R and R′ are a PAG and/or a base quencher, the PAG or base quencher may or may not be the same as the PAG and base quencher shown at O-PAG and O-BASE respectively. In other words, the actual number and types of moieties attached to an oligomer may depend upon the particular oligomer and/or the desired characteristics of the embodiment of the molecular resist. Thus, an embodiment of the present invention is not limited to a specific number and type of moieties attached to the base oligomer.

Referring to FIG. 6, a substrate, such a wafer, may be prepared for coating with an embodiment of a molecular resist. Preparation for coating may be done according to procedures known in the art.

As shown in box 20, the wafer may be coated with a liquefied form of a resist incorporating a multifunctional molecular resist molecule according to an embodiment of the present invention. For example, in one embodiment, a given multifunctional molecular resist molecule may be dissolved in a solvent such as propylene glycol methyl ether acetate (PGMEA), ethyl lactate, or cyclohexanol, although embodiments are not limited thereto. In some embodiments, additives such as adhesion promoters, surfactants, and/or base quenchers may be added to the resist solution, although embodiments of the present invention are not limited to particular additives, if any. The liquefied molecular photoresist may be applied to the wafer by spin coating, or any other suitable technique.

After coating a wafer with an embodiment of the molecular resist, the wafer may be heated as shown in box 22. The pre-bake or soft bake is optional in some embodiments. If a pre-bake is desired, the bake may be for a suitable time and temperature, and perhaps cooldown as is known in the art.

The resist-coated wafer may be exposed to radiant energy through a mask or reticle as shown in block 24. Generally, the wafer is aligned before exposure to allow the proper transfer of the pattern from the mask or reticle to an embodiment of the molecular photoresist. After alignment, the wafer is exposed to radiant energy, which may transform a characteristic of the exposed portion of the molecular resist. For example, in some embodiments, a portion of the resist is exposed to ultraviolet light having a wavelength of about 4 nm to about 250 nm. In one embodiment, portions of the molecular resist may be exposed to a wavelength of about 13.4 nm. The exposed portion of the resist may become more soluble in a developer solution, although embodiments are not so limited. In certain embodiments of the present invention, the source of radiant energy may be a lamp or a laser. Alternatively, an electron beam or another source may be used to image an embodiment of the resist.

After exposure, the wafer may be heated in some instances, as shown in block 26. Heating times and temperatures may be carefully controlled as is known in the art. One exemplary temperature is about 115° C. In some embodiments, acid catalyzed deprotection reactions may take place during the post-exposure bake (PEB) to render the exposed regions of the molecular resist more soluble in developer, although embodiments are not so limited.

After exposure or exposure and PEB, an embodiment of the molecular photoresist may be developed, which is shown in block 28. Generally, soluble portions of the molecular resist are dissolved in developer such as tetramethyl-ammonium hydroxide (TMAH) or another developer with a good dissolution rate and high selectivity. In this way, the desired three dimensional pattern is transferred to an embodiment of the molecular resist. Development may be for an appropriate temperature and time utilizing techniques known in the art such as continuous spray development or puddle development, although embodiments are not limited thereto.

After development, the resist coated wafer may be further processed and inspected for defects. After inspection, the resist pattern may be transferred to the wafer. In this way, a resist incorporating an embodiment of a multifunctional molecular resist molecule may be utilized to transfer patterns having a critical dimension in the sub micrometer range. In some instances, an embodiment of the molecular resist may be exposed to EUV to print patterns in the nanometer range such as about 35 nm.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. a molecular photoresist comprising:
a primary molecule other than a polymer chain; and
a photoacid generator attached to said primary molecule.

2. The photoresist of claim 1 wherein said primary molecule has a ring structure.

3. The photoresist of claim 2 wherein said ring structure is a derivative of calixarene.

4. The photoresist of claim 1 wherein said primary molecule is an oligomer.

5. The photoresist of claim 4 wherein said oligomer has four fused rings.

6. The photoresist of claim 1 including a protecting group attached to said primary molecule, said protecting group selected from the group consisting of tert-butoxycarbonyl, tert-butyl acrylate, t-butyl methacrylate, methyl methacrylate, t-butoxycarbonylmethyl, methoxyethoxymethyl, and t-butyl ether.

7. The photoresist of claim 1 wherein the photoacid generator is an ionic salt.

8. The photoresist of claim 7 wherein said photoacid generator is attached to said primary molecule at an anionic portion of said ionic salt.

9. The photoresist of claim 7 wherein said photoacid generator is attached to said primary molecule at a cationic portion of said ionic salt.

10. The photoresist of claim 1 wherein the photoacid generator is a nonionic photoacid generator.

11. The photoresist of claim 1 wherein the photoacid generator is a photoacid generator selected from the group consisting of triphenylsulfonium nonaflate, triphenylsulfonium triflate, diphenyliodium nonaflate, norbornene dicarboximidyl nonaflate, and norbornene dicarboximidyl triflate.

12. The photoresist of claim 1 including a base quencher attached to said primary molecule.

13. The photoresist of claim 12 wherein said base quencher is a base quencher selected from the group consisting of tetrabutylammonium hydroxide, trioctylamine, triethanolamine, tetrabutylamine, tetrethylamine, and an aromatic amine.

14. The photoresist of claim 1 including a solvent to dissolve said photoresist molecules.

15. A method comprising coating a substrate with a molecular photoresist comprising a primary molecule other than a polymer and a photoacid generator attached to said primary molecule.

16. The method of claim 15 including exposing said molecular photoresist to ultraviolet light having a wavelength between about 4 nanometers and about 250 nanometers.

17. The method of claim 16 including baking said substrate with said exposed molecular photoresist.

18. The method of claim 16 including developing said exposed molecular photoresist with a developer.

19. The method of claim 15 wherein coating said substrate includes coating a wafer.

20. The method of claim 15 wherein coating a substrate includes coating said substrate with said molecular photoresist including a photoacid generator selected from the group consisting of triphenylsulfonium nonaflate, triphenylsulfonium triflate, diphenyliodium nonaflate, norbornene dicarboximidyl nonaflate, and norbornene dicarboximidyl triflate.

21. A method comprising:
attaching a photoacid generator to a primary molecule other than a polymer; and
attaching a protecting group to said primary molecule.

22. The method of claim 21 wherein attaching a photoacid generator includes attaching a photoacid generator to a primary molecule having a radius of gyration of less than about 3 nanometers.

23. The method of claim 21 wherein attaching a photoacid generator includes attaching a photoacid generator to a primary molecule having a radius of gyration of less than about 1.5 nanometers.

24. The method of claim 21 wherein attaching a photoacid generator to a primary molecule includes attaching the photoacid generator to a derivative of calixarene.

25. The method of claim 21 wherein attaching a photoacid generator to a primary molecule includes attaching the photoacid generator to an oligomer having four fused rings.

26. The method of claim 21 wherein attaching a photoacid generator includes attaching a photoacid generator selected from the group consisting of triphenylsulfonium nonaflate, triphenylsulfonium triflate, diphenyliodium nonaflate, norbornene dicarboximidyl nonaflate, and norbornene dicarboximidyl triflate.

27. The method of claim 21 wherein attaching a photoacid generator includes attaching an anionic portion of an ionic photoacid generator to said primary molecule.

28. The method of claim 21 wherein attaching a protecting group includes attaching a protecting group selected from the group consisting of tert-butoxycarbonyl, tert-butyl acrylate, t-butyl methacrylate, methyl methacrylate, t-butoxycarbonylmethyl, methoxyethoxymethyl, and t-butyl ether.

29. The method of claim 21 including attaching a base quencher to said primary molecule.

30. The method of claim 29 wherein attaching a base quencher includes attaching a base quencher selected from the group consisting of tetrabutylammonium hydroxide, trioctylamine, triethanolamine, tetrabutylamine, tetrethylamine, and an aromatic amine.
